(19) United States
(12) Patent Application Publication
(10) Pub. No.: US 2008/0056079 A1
(43) Pub. Date: Mar. 6, 2008

(54) OPTICAL DISC DRIVE AND METHOD OF CONTROLLING THE SAME

(75) Inventor: Jae Hyun KIM, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/750,508

(22) Filed: May 18, 2007

(30) Foreign Application Priority Data
Sep. 5, 2006 (KR) 2006-85344

(51) Int. Cl. G11B 7/00

(52) U.S. Cl. 369/44.28; 369/44.32; 369/53.28

(57) ABSTRACT

An optical disc drive and a method of controlling the same. The optical disc drive includes: a pickup module to apply a laser beam to a surface of a record layer of an optical disc, and forming a focal point on the record-layer surface; and a servo controller to correct (e.g., iteratively or otherwise) the servo gain to allow a record-servo gain to move along a playback-servo gain of the optical disc. Therefore, the optical disc drive and associated method provide servo-control.

### CROSS-REFERENCE TO RELATED APPLICATIONS

This application claims the priority of Korean Patent Application No. 2006-0085344, filed on Sep. 5, 2006 in the Korean Intellectual Property Office, the disclosure of which is incorporated herein in its entirety by reference.

### BACKGROUND OF THE INVENTION

1. Field of the Invention

The present general inventive concept relates to a disc drive and a method of controlling the same, and more particularly to an optical disc drive to improve focusing and/or tracking using a focus-error signal and/or a tracking-error signal, and a method of controlling the same for improved performance.

2. Description of the Related Art

An optical disc drive applies a laser beam to a spiral track formed on the surface of a record layer of an optical disc, such that it records or reads information of the optical disc. The recording of the information is achieved by forming pits on the track. The reading of the information is achieved by analyzing a variation in the magnitude of a laser beam reflected from the track.

The laser beam reflected from a semiconductor laser diode is focused on the track via an objective lens or prism arranged at an optical path so as to configure a beam spot having a diameter less than several micrometers (μm). In order to record or reproduce information to/from the optical disc, the above-mentioned beam spot having a very narrow width must be continuously focused in the target track.

However, if the optical disc has a curvature of about 20 μm in the optical disc surface, or has a track eccentricity of about 50 μm, it significantly varies the track in relation to its normal path especially during rotation of the optical disc. Therefore, in order to focus the beam spot on a target track, the objective lens must be controlled by a focus-servo control system and a tracking-servo control system.

The focus-servo control system drives or moves the objective lens along a path on the basis of a line normal to the optical disc surface, and thereby focuses the size of the beam spot so that it can form a desired-sized beam spot on the target track. The tracking-servo control system controls the objective lens so that the location of the beam spot is maintained along the center of the desired target track. The size and location of the beam spot allow both the focus-error signal of the focus-servo control system and the tracking-error signal of the tracking-servo control system to be minimized or reduced.

When a variety of optical discs are loaded in the optical disc drive, control parameters of the servo-control systems for recording/reproducing data to/from the optical discs may vary. Also, the above-mentioned optical discs do not have the same characteristics. Thus, the optical disc drive must adjust the parameters of the servo-control system to yield optimum or appropriate performance. The correction of the focus-error signal and/or the tracking-error signal may be executed whenever the optical disc is loaded in the optical disc drive, and/or may also be executed at a variety of locations of a single optical disc depending on different disc characteristics on suitable individual locations of the particular optical disc being used.

There are a variety of conventional servo-control compensation methods, for example, a continuous servo-control method and a sample/hold (i.e., a sample & hold) servo-control method, etc.

The continuous servo-control method employs a fixed gain. For this purpose, the continuous servo-control method measures a difference between a first servo gain in the case of recording data in the optical discs and a second servo gain in the case of reproducing data from the optical discs, and applies a fixed servo-gain appropriate for the characteristics of an individual optical disc. However, the above-mentioned continuous servo-control method must obtain the servo gains acquired when data is recorded to or reproduced from the optical discs. If the appropriate servo-gains are not obtained, the continuous servo-control method employs an average servo-gain so that it is difficult to acquire an optimum servo-gain. Employing the average servo-gain is inappropriate for certain optical discs so that optimum or adequately improved performance is not achieved.

When recording data to the optical disc, each marking period employs a pulse-type record power at a high level, and a space period between the marking periods employs a single-level power such as either a bias power or a relatively-low erasing power.

The sample & hold servo control method samples the servo signals in the space period using the above-mentioned difference in power, and holds the sampled signal in the marking period. However, the sample & hold servo control method requires a high-speed switching operation to perform the switching between the sampling mode and the holding mode. Higher switching speeds are needed for the higher record capacity of high-density optical discs. Therefore, there may arise unexpected noise in a high-density optical disc. Also, if a sampling power level is different from a playback power level, the sample & hold servo control method must obtain servo gains for every optical disc in the same manner as in the above-mentioned continuous servo-control method.

### SUMMARY OF THE INVENTION

The present general inventive concept provides an optical disc drive and a method of controlling the same, which is sufficient to yield a servo-control margin (of a pickup module) to implement a stable servo-control operation.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an optical disc drive and a method of controlling the same, which includes measuring a record gain capable of adequately guaranteeing a servo-control margin at some inner-areas of a Power Calibration Area (PCA), sufficient to prevent, minimize or adequately reduce a data-overwriting problem from occurring which interferes with recording of data in an optical disc.

The foregoing and/or other aspects and utilities of the present general inventive concept may be achieved by providing an optical disc drive and a method of controlling the same, which includes controlling a servo-gain on the basis of a level detection (or level calculation) result of an S-curve of a focus-error signal to minimize the magnitude of overwriting inaccurate or corrupted data recorded in an optical disc.

The foregoing and/or other aspects and utilities of the present general inventive concept may be achieved by providing an optical disc drive including: a pickup module to apply a laser beam to a record-layer surface of an optical disc to form a focal point on the record-layer surface; and a servo controller to correct servo gain to allow a record-servo gain to move along a playback-servo gain of the optical disc.

According to an embodiment of the present general inventive concept, the servo controller acquires the record-servo gain of the optical disc on the basis of at least one focus-error signal level.

According to another embodiment of the present general inventive concept, the servo controller includes: a level detector to detect at least one focus-error signal level; and a gain controller to acquire the record-servo gain of the optical disc on the basis of the detection result of the level detector which includes, comparing the record-servo gain with the playback-servo gain of the optical disc, and generating gain-correction information required for the record-servo gain to move along the playback-servo gain.

According to another embodiment of the present general inventive concept, the servo controller acquires the record-servo gain of the optical disc on the basis of an average level of a plurality of focus-error signals (e.g., 2, 3, 4, 5, 6, 7, . . . N focus-error signals).

According to another embodiment of the present general inventive concept, the servo controller generates the at least one focus-error signal in a PCA (Power Calibration Area) of the optical disc, and detects a level of the generated focus-error signal.

According to another embodiment of the present general inventive concept, the servo controller generates the at least one focus-error signal in selected areas of an inner area of the PCA of the optical disc, and detects the generated focus-error signal.

According to another embodiment of the present general inventive concept, the servo controller switches off a focus-servo when the at least one focus-error signal is generated, and vertically moves an objective lens of the pickup module.

In accordance with another embodiment of the present general inventive concept, there is provided a method to control an optical disc drive which includes a pickup module for applying a laser beam to a surface of a record layer (record-layer surface) of an optical disc, and forming a focal point on the record-layer surface; and a servo controller to correct a servo gain to allow a record-servo gain to move along a playback-servo gain of the optical disc, the method includes: a) generating at least one focus-error signal, and detecting a level of the generated focus-error signal; b) acquiring the record-servo gain of the optical disc on the basis of the level of the at least one focus-error signal; and c) correcting the record-servo gain to move the record-servo gain along the playback-servo gain of the optical disc.

According to another embodiment of the present general inventive concept, the method further includes: d) comparing the record-servo gain with the playback-servo gain of the optical disc, and generating gain-correction information to move the record-servo gain along the playback-servo gain.

According to another embodiment of the present general inventive concept, the record-servo gain of the optical disc is acquired on the basis of an average level of a plurality of focus-error signals.

According to another embodiment of the present general inventive concept, the at least one focus-error signal is generated from a PCA (Power Calibration Area) of the optical disc, so that a level of the generated focus-error signal is detected (e.g., automatically).

According to another embodiment of the present general inventive concept, the at least one focus-error signal is generated from selected areas of an inner area of the PCA of the optical disc, so that a level of the generated focus-error signal is detected.

According to another embodiment of the present general inventive concept, an objective lens of the pickup module is vertically moved when a focus-servo is switched off and when the at least one focus-error signal is generated.

In accordance with yet another embodiment of the present general inventive concept, there is provided a method to control an optical disc drive which includes a pickup module to apply a laser beam to a surface of a record layer of an optical disc, and forming a focal point on the record-layer surface; and a servo controller to correct the servo gain to move a record-servo gain along a playback-servo gain of the optical disc, the method including: moving the pickup module to a PCA (Power Calibration Area) of the optical disc; generating at least one focus-error signal in the PCA of the optical disc, and detecting a level of the generated focus-error signal; acquiring the record-servo gain of the optical disc on the basis of the level of the at least one focus-error signal; and correcting the record-servo gain to move the record-servo gain along the playback-servo gain of the optical disc.

According to an embodiment of the present general inventive concept, the correcting step may be iteratively conducted.

Pursuant to another embodiment of the present general inventive concept, a method of controlling an optical disc drive having a pickup module that applies a laser beam to a surface of a record layer of an optical disc is provided. The method includes: detecting an S-curve level of a focus-error signal (FE) from an RF signal received from the pickup module when data is recorded on the optical disc; calculating a record-servo gain based on the detected S-curve level; retrieving playback servo data from a memory; generating gain-correction information from a comparison result between the playback servo data and the calculated record-servo gain; and correcting a focus drive signal and a tracking drive signal of the pickup module using the gain correction information.

Pursuant to another embodiment of the present general inventive concept, a control unit to control a pickup module of an optical disc drive is provided. The controller may include: a first input to receive at least one tracking error signal (TE) from a radio frequency (RF) signal of the pickup module; a second input to receive the at least one focus error signal (FE) from the RF signal; a first generator to calculate a focus drive signal (FOD) based on the at least one focus error signal, at least one focus error signal level or an average focus error signal level; a second generator to calculate a tracking drive signal (TRD) based on at least one tracking error signal; a first output to transmit the FOD to the pickup module; and a second output to transmit the TRD to the pickup module. Also, the first generator may calculate the focus drive signal (FOD) based on the at least one focus error signal level of an S-curve level or based on the average focus error signal level of a plurality of S-curve levels.

According to another embodiment of the present general inventive concept, a control unit to control a pickup module of an optical disc drive is provided. The control unit may include an input to receive at least one tracking error signal (TE) and at least one focus error signal (FE) from a radio frequency (RF) signal of the pickup module; a generator to calculate a focus drive signal (FOD) based on the at least one focus error signal, at least one focus error signal level or an average focus error signal level and to calculate a tracking drive signal (TRD) based on the at least one tracking error signal; and an output to transmit the FOD and the TRD to the pickup module. The generator may calculate the focus drive signal (FOD) based on the at least one focus error signal level of an S-curve level or based on the average focus error signal level of a plurality of S-curve levels.

Preferably, the at least one focus-error signal is generated from some areas of an inner area of the PCA of the optical disc, such that a level of the generated focus-error signal is detected.

Preferably, an objective lens of the pickup module vertically moves on the condition that a focus-servo is switched off when the at least one focus-error signal is generated.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a structural diagram illustrating the appearance of a recordable or writable optical disc according to an embodiment of the present general inventive concept;

FIG. 2 is a cross-sectional view illustrating the recordable or writable optical disc illustrated in FIG. 1 according to an embodiment of the present general inventive concept;

FIG. 3 is a block diagram illustrating an optical disc drive according to an embodiment of the present general inventive concept;

FIG. 4 is a block diagram illustrating an exemplary servo controller illustrated in FIG. 3 according to an embodiment of the present general inventive concept;

FIG. 5 is a conceptual diagram illustrating a method of detecting (or calculating) an S-curve level of a focus-error signal capable of detecting a servo-gain according to and embodiment of the present general inventive concept;

FIG. 6 is a structural diagram illustrating an S-curve level detection (or calculation) area of the focus-error signal capable of detecting a servo-gain according to an embodiment of the present general inventive concept; and

FIGS. 7A and 7B are flow charts illustrating a method of controlling the optical disc drive according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

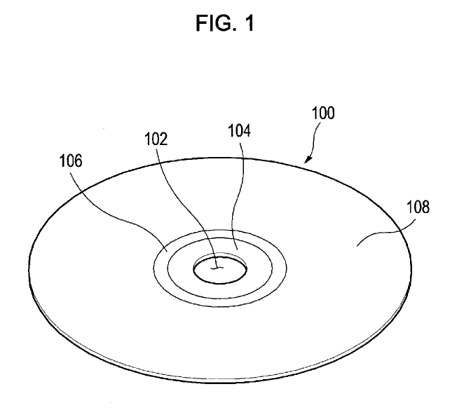

FIG. 1 is a structural diagram illustrating the appearance of a recordable or writable optical disc according to an embodiment of the present general inventive concept. Referring to FIG. 1, a clamping hole 102 is located at the center part of an optical disc 100 (hereinafter referred to as a multi-layer optical disc) including a plurality of record layers capable of recording data therein. One end of a rotation axis to rotate the optical disc 100 seated in the optical disc drive is inserted into the clamping hole 102. A clamping unit 104 to fix the optical disc 100 rotating in the optical disc drive is arranged at a peripheral area of the clamping hole 102. PCA (Power Calibration Area) 106 and an information area 108 are sequentially arranged in the vicinity of the clamping unit 104 in the direction from an inner area of the optical disc 100 to an outer area.

The PCA 106 is indicative of a test area to optimize the record power of a laser beam focused on a data record surface of the optical disc 100. The higher the number of power calibrations, the smaller the size of the PCA 106. Information indicating the number of power calibrations is recorded as count data.

The information area 108 is a specific area in which data is actually recorded. If data is recorded in the information area 108, at least one Lead-In area, at least one data area, and at least one Lead-Out area are sequentially arranged in the information area 108. If a recording apparatus capable of performing a multi-session process and an optical disc for the multi-session are used, the information area 108 includes a predetermined number of groups, each of which includes “Lead-In area→Data Area→Lead-Out area”, proportional to the number of multi-sessions.

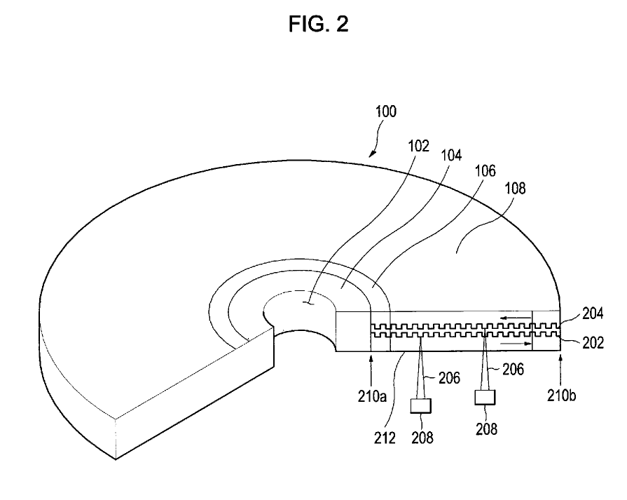

FIG. 2 is a cross-sectional view illustrating the recordable or writable optical disc illustrated in FIG. 1 according to an embodiment of the present general inventive concept. Referring to FIG. 2, the optical disc 100 includes two record layers 202 and 204 to record data therein. In the case of the optical disc of at least two record layers (e.g., a dual-layer optical disc) 202 and 204, a lower record layer 202 is represented by a “record layer 0” (Layer 0), and an upper record layer 204 is represented by a “record layer 1 ” (Layer 1).

A protection layer to protect the record layer 202 (Layer 0) from external impact is included in the record layer 202 (Layer 0). The surface of the protection layer is denoted as the disc surface 212.

Each of the two record layers 202 and 204 contained in the optical disc 100 includes successive spiral tracks, each of which records data. A pickup module 208 to record/reproduce/erase data in/from each record layer 202 or 204 moves from an inner area 210a to the outer area 210b of the optical disc 100, or moves from the outer area 210b to the inner area 210a, and at the same time applies a laser beam 206 to a track of a corresponding record layer.

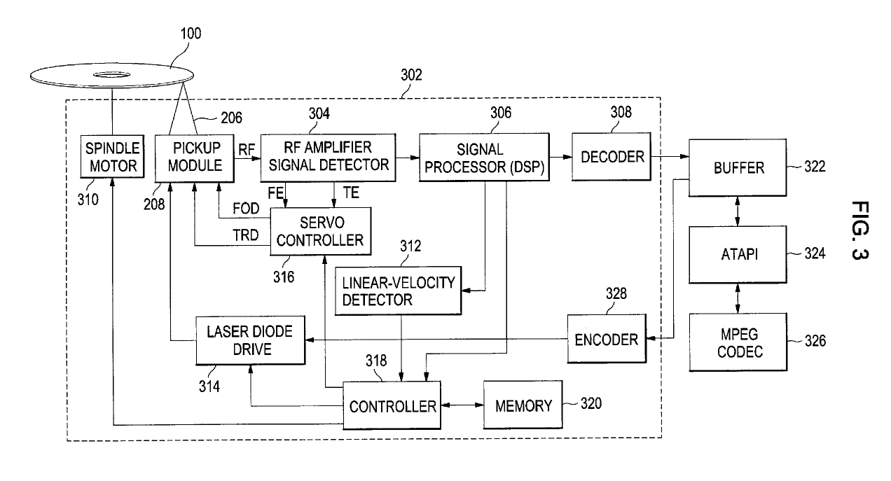

FIG. 3 is a block diagram illustrating an optical disc drive according to an embodiment of the present general inventive concept. Referring to FIG. 3, the reference number 302 refers to an optical disc drive. The reference number 322 refers to a buffer. The reference number 324 refers to an ATAPI (Advanced Technology Attachment Packet Interface). The reference number 326 refers to an MPEG CODEC. If required, the buffer 322, the ATAPI interface 324, and the MPEG CODEC 326 may also be contained in the optical disc drive 302. The ATAPI is a representative data communication interface between the optical disc drive and a CODEC chip.

Referring to FIG. 3, the optical disc 100 is rotated by a spindle motor 310. The spindle motor 310 is controlled by a drive signal generated from the controller 318.

The pickup module 208 includes a laser diode, and applies a laser beam 206 having a specific record power to a record surface of the optical disc 100 via a laser diode, so that data may be recorded in the optical disc 100. The laser beam 206 having a specific power equal to a record power may be applied to the optical disc 100, so that the data recorded in the optical disc 100 is reproduced and/or read. In the case of erasing data of the optical disc, the pickup module 208 may use a specific erasing power.

When recording data in the optical disc 100, record data is encoded by the encoder 328, and is then applied to the laser diode drive 314. The controller 318 transmits a drive signal to drive the encoded data in the data record surface of the optical disc 100 to the laser diode drive 314, to change the record power of the laser diode.

When reproducing data from the optical disc 100, the controller 318 controls the laser diode contained in the pickup module 208, generates the laser beam 206 having a specific power equal to a playback power, and applies the generated laser beam to the data-record surface of the optical disc 100. The laser beam applied to the optical disc 100 is reflected from the data-record surface of the optical disc, and is received in a light receiving part (e.g., a photo-diode) contained in the pickup module 208. The light receiving part generates an RF (Radio Frequency) signal corresponding to a magnitude of the received laser beam. The RF amplifier 304 receives the RF signal, amplifies, and converts the amplified RF signal into a binary signal. The binary signal received from the RF amplifier 304 is restored to digital data by the signal processor (DSP) 306. The restored digital data is encoded. The decoder 308 decodes the encoded digital data to digital data created prior to the encoding.

The signal processor (DSP) 306 calculates a variety of values (i.e., β, α, a peak value, a bottom value, and an average value, etc.) from the RF signal, and provides the calculated values to the controller 318.

The linear-velocity detector 312 detects a linear velocity of the rotating optical disc 100, and provides the controller 318 with the detected linear velocity.

The RF amplifier 304 detects a tracking-error signal (TE) and a focus-error signal (FE) from the received RF signal, and transmits the tracking-error signal (TE) and the focus-error signal (FE) to the servo controller 316. The servo controller 316 generates a focus-drive signal (FOD) on the basis of the focus-error signal (FE), and performs the focus-servo control operation of the pickup module 208. The focus-drive signal (FOD) is adapted to drive a focus actuator to move an objective lens of the pickup module 208.

The focus actuator controls recording data in the surfaces of the record layers 202 and 204. The focus actuator controls movement along a normal-line direction of the record layers 202 and 204 during the vibration of the objective lens. The focus-drive signal (FOD) mechanically moves the objective lens along a beam-axis direction indicative of the normal line direction of the disc surface 212. In this case, the above-mentioned mechanical movement can more basically adjust a distance between the objective lens and the optical disc 100, differently from the focus actuator capable of controlling movement along the surfaces of the record layers 202 and 204. The servo controller 316 generates a tracking drive signal (TRD) on the basis of the tracking-error signal (TE) along with the above-mentioned focus-servo control method to track the tracking of the pickup module 208.

Referring to FIG. 3, the controller 318 can control overall operations of the optical disc drive 302. An external memory 320 to store data required to control the overall operations of the optical disc drive 302 or data required for the control process of the optical disc drive 302 is connected to the controller 318. Particularly, according to an embodiment of the present general inventive concept, playback servo-gain data and record servo-gain data of the loaded optical disc 100 are stored in the external memory 320. The controller 318 transmits the playback servo-gain data stored in the external memory 320 to the servo controller 316, to adjust the gain of the servo controller 316.

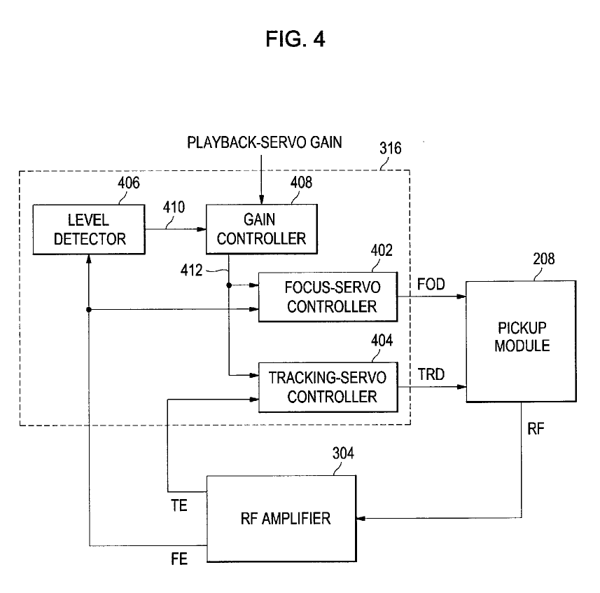

FIG. 4 is a block diagram illustrating an exemplary servo controller illustrated in FIG. 3 according to an embodiment of the present general inventive concept.

Referring to FIG. 4, the servo controller 316 includes a focus-servo controller 402 and a tracking-servo controller 404. The focus-servo controller 402 performs a focus-servo control operation of the pickup module 208, so that the laser beam generated from the pickup module 208 can form an accurate-sized beam spot on the surfaces of the record layers 202 and 204 of the optical disc 100. The tracking-servo controller 404 performs a tracking-servo control operation of the pickup module 208, so that a focal point of the laser beam generated from the pickup module 208 moves along a spiral track formed on the surfaces of the record layers 202 and 204 of the optical disc 100.

A level detector 406 detects an S-curve level of the focus-error signal (FE) detected when data is recorded in the PCA 106 of the optical disc 100, and transmits S-curve level information 410 to the gain controller 408.

The gain controller 408 calculates a record-servo gain on the basis of the S-curve level information 410 of the focus-error signal received from the level detector 406. The gain controller 408 generates gain-correction information 412 according to the comparison result between a playback-servo gain and the record-servo gain stored in the external memory 320, so that the magnitude of the record-servo gain moves along the magnitude of the playback servo gain. The gain-correction information 412 is transmitted to the focus-servo controller 402 and the tracking-servo controller 404, to correct the gain of the servo-controller 316.

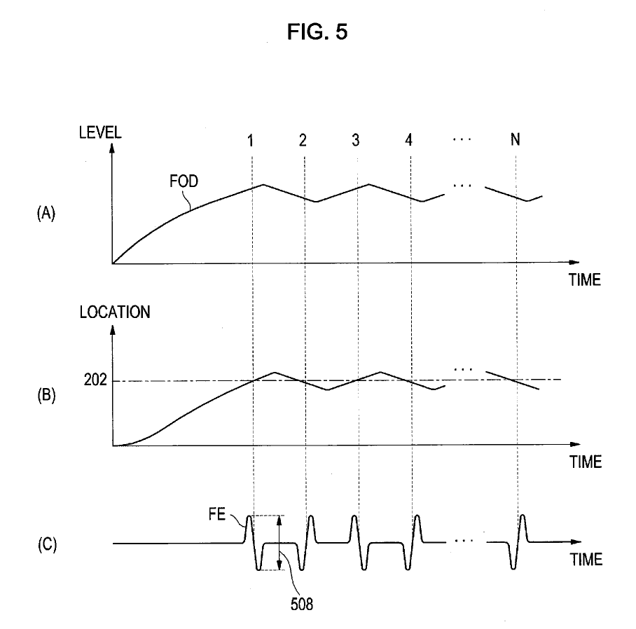

FIG. 5 is a conceptual diagram illustrating a method of detecting an S-curve level of a focus-error signal capable of detecting a servo-gain according to an embodiment of the present general inventive concept. In more detail, FIG. 5A is a graph illustrating the focus-drive signal (FOD) versus time, FIG. 5B is a graph illustrating relative locations of a focal point of the pickup module 208 on a beam axis on the basis of the surface of the record layer 202 of the optical disc 100 on the beam axis versus time, and FIG. 5C is a graph illustrating the focus-error signal (FE) versus time.

As illustrated in FIGS. 5A to 5C, if the focus-drive signal (FOD) vertically vibrates on the basis of a specific level, the focal point of the pickup module 208 also vertically vibrates on the beam axis. If a specific level at which the focus-drive signal (FOD) vibrates corresponds to a location of the record layer 202's surface, the focal-point vertical vibration corresponding to the FOD's vertical vibration is executed on the basis of the surface of the record layer 202 of the optical disc 100 as can be seen from FIG. 5B. The focus error signal (FE) generates an S-curve whenever the focal point of the pickup module 208 passes the surface of the record layer 202. The optical disc drive according to the embodiments of the the present general inventive concept encounters a predetermined number of S-curves in the focus-error signal (FE), detects the level 508 of each S-curve, and employs an average value of individual S-curve levels 508 to calculate the record-servo gain.

The optical disc drive according to embodiments of the present general inventive concept calculates the record-servo gain using the focus-error signal (FE) to reduce or minimize an amount of data recorded in the record layer 202 of the optical disc 100 while calculating the record-servo gain, and to restrict the range of a data record area within a predetermined range.

In order to correct the record-servo gain using the S-curve level of the tracking-error signal (TE), the optical disc drive must switch off the tracking-servo control on the condition that the focus-servo is activated or switched on. In this case, the tracking-servo control operation cannot be executed and data recording between neighboring tracks may be indiscriminately performed. However, if the optical disc drive switches off the focus-servo control on the condition that the tracking-servo control is switched on, it may allow the S-curve of the focus-error signal for acquiring the record-servo gain to be executed within only a predetermined area of the record layer 202. Also, the optical disc drive forms pits (or marks) at only a zero-crossing point of N S-curves of the focus-error signal (FE) during a very short time, resulting in the reduction minimization of the magnitude of inaccurate or corrupted data.

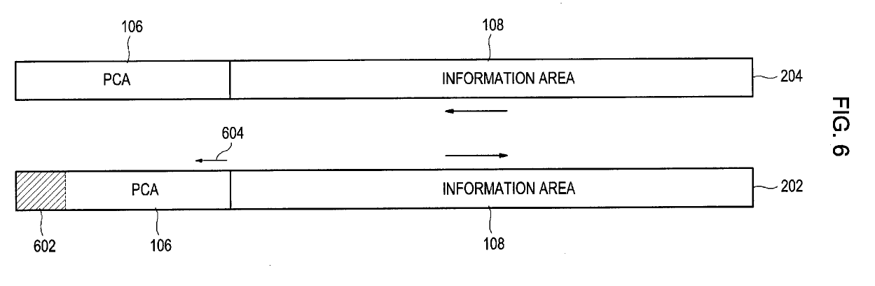

FIG. 6 is a structural diagram illustrating an S-curve level detection area of the focus-error signal capable of detecting a servo-gain according to an embodiment of the present general inventive concept. Referring to FIG. 6, some parts of an innermost inner area of the PCA 106 are a test record area 602 to correct the record-servo gain. N S-curves of the focus-error signal may be obtained in the test record layer 602, so that the levels of the N S-curves are detected.

The power-correction process in the PCA 106 of the record layer 202 starts from the outer area to the inner area of the PCA 106, as denoted by the arrow 604. Therefore, according to an embodiment of the present general inventive concept, some parts of the inner area (at which the power correction is performed later) of the PCA 106 are adapted to detect the S-curve level 508 of the focus-error signal (FE). If the S-curve level of the focus-error signal (FE) is detected from the information area 108, undesirable data-record traces are left in the information area 108, so that the data-record traces may unexpectedly create or lead to an overwriting problem during data recording. In other words, undesirable new data is re-recorded at a record location of old data corrupting the old data. Therefore, if some parts of the inner area of the PCA 106 are used as the S-curve level detection area of the focus-error signal (FE), such use prevents the above-mentioned overwriting problem from being generated in the information area 108.

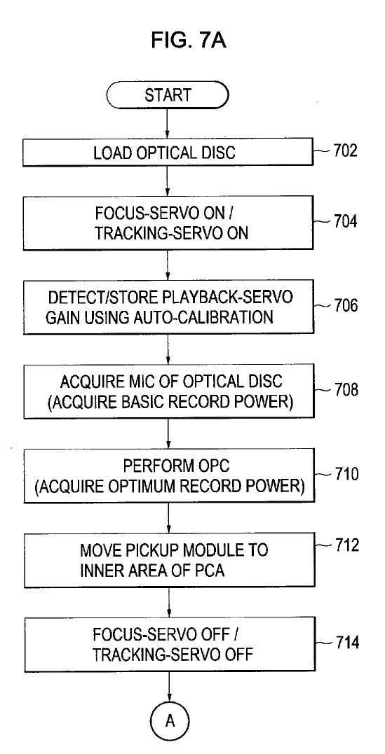

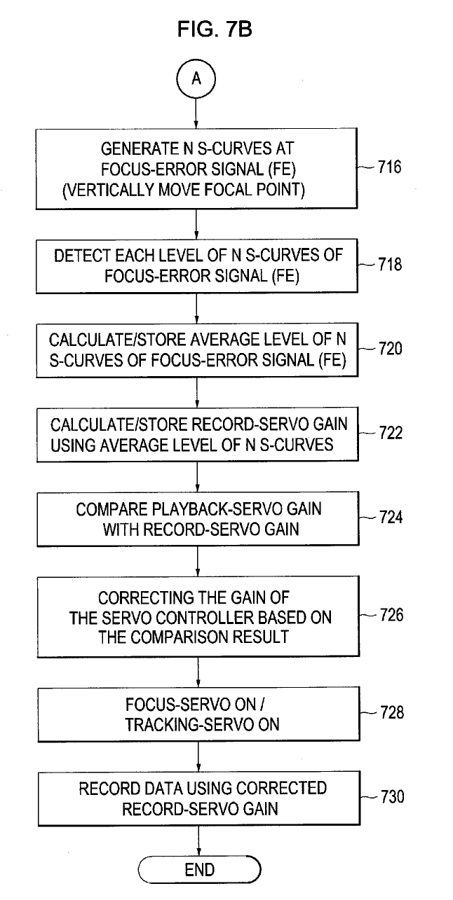

FIGS. 7A and 7B are flow charts illustrating a method of controlling the optical disc drive according to an embodiment of the present general inventive concept.

Referring to FIGS. 7A and 7B, it is determined whether the optical disc 100 is loaded in a tray (not referenced) of the optical disc drive 302 at operation 702. If the optical disc 100 is loaded in the tray of the optical disc drive 302, the optical disc drive 302 actuates (or switches on) the focus servo controller 402 and the tracking servo controller 404 of the servo controller 316 at operation 704. Thereafter, the optical disc drive detects a playback servo-gain of the optical disc 100, and stores the playback servo-gain in the external memory 320 at operation 706.

It is/may be desirable to determine an optimum record power to record data in the optical disc 100. The optical disc drive 302 acquires a basic record power provided from a manufacturing company of the optical disc 100 at an MID (Media IDendification) of the optical disc 100 prior to determining the optimum record power at operation 708. However, the above-mentioned basic record power is determined by only physical characteristics of the optical disc 100, and does not include factors of peripheral environments (e.g., an inner temperature of the optical disc drive 302), so that the optical disc drive performs an OPC (Optimum Power Correction) to acquire more-optimized record power at operation 710.

The optical disc drive detects N (N=an integer of 1 or more) S-curves from some parts of the PCA 106 of the optical disc 100. To do so, the pickup module 208 is moved to a predetermined area 602 of the PCA 106 of the optical disc 100 at operation 712. If the pickup module 208 moves to the predetermined area 602 of the PCA 106 of the optical disc 100, the optical disc drive switches off the focus servo and the tracking servo at operation 714.

Referring to FIG. 7B, the optical disc drive repeats up/down operations of the pickup module 208 while the focal point of the pickup module 208 is maintained in the predetermined area 602 of the PCA 106 of the optical disc 100. The focal point vibrates in the vertical direction of the record layer 202, and N S-curves and the focus-error signals (FEs) are generated at operation 716. The level detector 406 of the servo controller 316 detects the level 508 of each S-curve from the N S-curves, and transmits the detected S-curve level 508 to the gain controller 408 at operation 718. The gain controller 408 calculates an average level of the N S-curves of the focus-error signal (FE), and stores the calculated average level in the external memory 320 at operation 720.

The average level of the N S-curves of the focus-error signal is adapted to calculate a current gain of the servo controller 316. In more detail, in the case of comparing a previous focus-error signal (FE) level with a current focus-error signal (FE) level, the record servo gain of the controller 316 can be recognized by a difference between the previous and current FE levels. In this way, the optical disc drive calculates (e.g., iteratively such as in a continuously iterative fashion or a batch iterative fashion to correct the appropriate servo gain—for example, a record servo gain—in similar continuous or batch iterative fashion) the record-servo gain, and stores the calculated record-servo gain in the memory 320 at operation 722.

As previously stated at operation 706 of FIG. 7A, the optical disc drive has detected the playback-servo gain of the optical disc 100 using the auto calibration process, and has stored the detected playback-servo gain in the memory 320.

The above-mentioned playback-servo gain may be considered to be an optimum gain for reproducing/reading data from the optical disc. The optical disc drive according to an embodiment of the present general inventive concept compares the record-servo gain with the playback-servo gain, and calculates a difference between the record-servo gain and the playback-servo gain at operation 724. The optical disc drive corrects the gain of the servo controller 316 at operation 726, so that the record-servo-gain moves along the playback-servo gain. The playback-servo gain is optimized at the currently-loaded optical disc 100, so that the record-servo gain may also be optimized when the optical disc drive moves along the playback-servo gain.

If the gain of the servo controller 316 is optimized, the optical disc drive switches on the focus servo to record data in the information area 108 of the optical disc 100, maintains the ON-state tracking servo, and moves the pickup module 208 to the information area 108 at operation 728. If the pickup module 208 reaches a specific location of the information area 108 at which data is to be recorded, the optical disc drive records data using the corrected record-servo gain at operation 730. In the case of recording data in the optical disc, the record-servo gain is used for a specific record time during which a WriteGate signal is activated to implement data recording. Otherwise, the playback-servo gain is used for an idle time during which the WriteGate signal is inactivated, such that the data recording is not implemented.

In order to more correctly detect the focus-error signal (FE), it is preferable for the optical disc drive to generate N S-curves and use an average value of the N S-curve levels as previously stated above. However, if the optical disc drive employs a very large number of S-curves, it requires an unnecessary long period of time to generate many S-curves, detect the levels of the S-curves, and calculate the average value of the S-curve levels. Therefore, preferably, the optical disc drive may suitably adjust the number of the S-curves, so that an appropriate balance between the accurate-level detection and the above-mentioned working time is maintained.

Although the level detector 406 and the gain controller 408 are contained in the servo controller 316 as shown in FIG. 4, it should be noted that the level detector 406 and the gain controller 408 may also be arranged outside of the servo controller 316 as necessary.

As is apparent from the above description, the optical disc drive and method to control the same according to an embodiment of the present general inventive concept sufficiently improve a servo-control margin of a pickup module, resulting in the implementation of a more stable servo-control operation.

The optical disc drive and method to control the same according to an embodiment of the present general inventive concept measure a record gain capable of sufficiently guaranteeing or improving a servo-control margin at some inner-areas of a PCA area, thereby reducing the above-mentioned data-overwriting problem when data is later or subsequently recorded in an optical disc.

The optical disc drive and a method of controlling the same according to an embodiment of the present general inventive concept control a servo-gain on the basis of a level detection result of an S-curve of a focus-error signal, to reduce or minimize the magnitude of inaccurate or corrupted data recorded in an optical disc.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An optical disc drive comprising:
a pickup module to apply a laser beam to a record-layer surface of an optical disc, and to form a focal point on the record-layer surface; and
a servo controller to correct a servo gain to allow a record-servo gain to move along a playback-servo gain of the optical disc.

2. The optical disc drive according to claim 1, wherein the servo controller acquires the record-servo gain of the optical disc on the basis of at least one focus-error signal level.

3. The optical disc drive according to claim 2, wherein the servo controller includes:
a level detector to detect the at least one focus-error signal level; and
a gain controller to acquire a corrected record-servo gain of the optical disc on the basis of the detected result of the level detector or calculator, involving comparing the record-servo gain with the playback-servo gain of the optical disc, and generating gain-correction information required for the record-servo gain to move along the playback-servo gain.

4. The optical disc drive according to claim 3, wherein the servo controller acquires the corrected record-servo gain of the optical disc on the basis of an average level of a plurality of focus-error signals.

5. The optical disc drive of claim 3, wherein the corrected record-servo gain is iteratively corrected.

6. The optical disc drive of claim 5, wherein the record servo-gain is iteratively corrected on the basis of one or more focus-error signals, at least one focus-error signal level, or an average focus-error signal level.

7. The optical disc drive of claim 5, wherein the iteratively corrected record-servo gain is utilized to control vertical movement of an objective lens along a line normal to the record-layer surface of the optical disc.

8. The optical disc drive according to claim 2, wherein the servo controller generates the at least one focus-error signal in a PCA (Power Calibration Area) of the optical disc, and detects a level of the at least one focus-error signal.

9. The optical disc drive according to claim 8, wherein the servo controller generates the at least one focus-error signal in an inner area of the PCA of the optical disc, and detects the generated at least one focus-error signal.

10. The optical disc drive according to claim 9, wherein the servo controller switches off a focus-servo when the at least one focus-error signal is generated, and vertically moves an objective lens of the pickup module on the basis of a line normal to the record-layer surface.

11. A method of controlling an optical disc drive which includes a pickup module for applying a laser beam to a record-layer surface of an optical disc, and forming a focal point on the record-layer surface; and a servo controller for correcting a servo gain to allow a record-servo gain to move along a playback-servo gain of the optical disc, the method comprising:
generating at least one focus-error signal, and detecting a level of the generated at least one focus-error signal;
acquiring the record-servo gain of the optical disc on the basis of the level of the at least one focus-error signal; and
correcting the record-servo gain in order to allow the record-servo gain to move along the playback-servo gain of the optical disc.

12. The method according to claim 11, further comprising:
comparing the record-servo gain with the playback-servo gain of the optical disc, and generating gain-correction information required for the record-servo gain to move along the playback-servo gain.

13. The method according to claim 11, wherein the record-servo gain of the optical disc is acquired on the basis of an average level of a plurality of focus-error signals.

14. The method according to claim 11, wherein the at least one focus-error signal is generated from a PCA (Power Calibration Area) of the optical disc, such that a level of the generated at least one focus-error signal is detected.

15. The method according to claim 14, wherein the at least one focus-error signal is generated from some areas of an inner area of the PCA of the optical disc, such that a level of the generated at least one focus-error signal is detected.

16. The method according to claim 11, wherein an objective lens of the pickup module vertically moves on the condition that a focus-servo is switched off when generating the at least one focus-error signal.

17. A method of controlling an optical disc drive which includes a pickup module for applying a laser beam to a surface of a record layer of an optical disc, and forming a focal point on the record-layer surface; and a servo controller for correcting a servo gain to allow a record-servo gain to move along a playback-servo gain of the optical disc, the method comprising:
moving the pickup module to a PCA (Power Calibration Area) of the optical disc;
generating at least one focus-error signal in the PCA of the optical disc, and detecting a level of the generated focus-error signal;
acquiring the record-servo gain of the optical disc on the basis of the level of the at least one focus-error signal; and
correcting the record-servo gain.

18. The method according to claim 17, wherein the at least one focus-error signal is generated from an inner area of the PCA of the optical disc, such that a level of the generated focus-error signal is detected.

19. The method according to claim 17, wherein an objective lens of the pickup module vertically moves on the condition that a focus-servo is switched off when the at least one focus-error signal is generated.

20. The method of claim 11, wherein the correcting operation is iteratively conducted.

21. A method of controlling an optical disc drive having a pickup module that applies a laser beam to a surface of a record layer of an optical disc, the method comprising:
detecting an S-curve level of a focus-error signal (FE) from an RF signal received from the pickup module when data is recorded on the optical disc;
calculating a record-servo gain based on the detected S-curve level;
retrieving playback servo data from a memory;
generating gain-correction information from a comparison result between the playback servo data and the calculated record-servo gain; and
correcting a focus drive signal and a tracking drive signal of the pickup module using the gain correction information.

22. The method of claim 21, wherein the correcting or the generating operations are iteratively conducted.

23. The method of claim 22, wherein the correcting and the generating operations are iteratively conducted.

24. A control unit to control a pickup module of an optical disc drive, the control unit comprising:
an input to receive at least one tracking error signal (TE) and at least one focus error signal (FE) from a radio frequency (RF) signal of the pickup module;
a generator to calculate a focus drive signal (FOD) based on the at least one focus error signal, at least one focus error signal level or an average focus error signal level and to generate a tracking drive signal (TRD) based on the at least one tracking error signal; and
an output to transmit the FOD and the TRD to the pickup module.

25. The control unit of claim 24, wherein the generator calculates the focus drive signal (FOD) based on the at least one focus error signal level of an S-curve level or based on the average focus error signal level of a plurality of S-curve levels.
